(19) United States
(12) Patent Application Publication
(10) Pub. No.: US 2025/0389954 A1
(43) Pub. Date: Dec. 25, 2025

(54) MULTIPATH OPTICAL DEVICE

(71) Applicant: Snap Inc., Santa Monica, CA (US)

(72) Inventors: Alexandra Crai, Abingdon (GB); Alexander James Lewarne Webber, Rugby (GB); Mohmed Salim Valera, Sutton Coldfield (GB)

(21) Appl. No.: 19/108,062

(22) PCT Filed: Sep. 14, 2023
(86) PCT No.: PCT/EP2023/075362

§ 371 Date: Feb. 28, 2025

(30) Foreign Application Priority Data
Sep. 14, 2022 (EP) 22195747.5

(51) Int. Cl. G02B 27/01; G02B 27/42

(52) U.S. Cl. CPC G02B 27/0101; G02B 27/4205; G02B 2027/0118

(57) ABSTRACT

An optical device for use in an augmented reality or virtual reality display includes a waveguide and an input diffractive optical element (DOE) that receives light from a projector and couples it into the waveguide along multiple optical paths. The device includes an output DOE offset along a first direction to couple light towards a viewer, and a first turning DOE offset along a second different direction. The input DOE couples a first portion of light directly towards the output DOE in the first direction, while coupling a second portion in the second direction towards the first turning DOE, which then diffracts it towards the output DOE. The input DOE may comprise first and second gratings for diffracting the respective light portions. The device may include additional turning DOEs to handle light coupled in other directions.

### TECHNICAL FIELD

The present disclosure relates to optical devices suitable for use in displays such as augmented reality or virtual reality displays. Such optical devices typically comprise a waveguide and diffractive optical elements for coupling light into and out of the waveguide. Virtual reality and augmented reality displays include wearable devices, such as glasses, displays for video games, and screens for military or transportation applications.

### BACKGROUND

In a conventional augmented reality display, a transparent display screen is provided in front of a user so that they can continue to see the physical world. The display screen may be a glass waveguide, with a projector provided to one surface of the waveguide. The display screen may be provided in a pair of glasses or a window on a vehicle, for example. Light from the projector is coupled into the waveguide by an input diffraction grating. The projected light is totally internally reflected within the waveguide. The light is then coupled out of the waveguide by another diffraction grating so that it can be viewed by a user. The projector can provide information and/or images that augment a user's view of the physical world.

An optical device is disclosed in WO 2016/020643 for expanding input light in two dimensions in an augmented reality display. An input diffractive optical element is provided for coupling input light from a projector into a waveguide. The optical device also includes an output element having two diffractive optical elements overlaid on one another in the waveguide so that each of the two diffractive optical elements can receive light from the input diffractive optical element and couple it towards the other diffractive optical element in the pair, which can then act as an output diffractive optical element which couples light out of the waveguide towards a viewer. In one embodiment the two diffractive optical elements overlaid on one another are provided in a photonic crystal. This is achieved by having an array of pillars arranged within or on the surfaces of the waveguide, having an increased refractive index relative to the surrounding waveguide medium. This arrangement has been found to be very effective at simultaneously expanding light in two dimensions and coupling light out of the waveguide. Advantageously this can improve the use of space on the waveguide which can decrease the cost of manufacture.

WO 2018/178626 describes one issue which can occur in an output element having two diffractive optical elements overlaid on one another, wherein a central strip in the output image has been observed as having a higher relative brightness than other parts, because the waveguide is oriented such that light enters the output element along a center line of the output element, and a large proportion of the light is diffracted out of the waveguide in a central strip around the center line before the light can be expanded across the whole width of the output element perpendicular to the center line. Such a central strip 6 is shown in FIG. 2, which is discussed further below.

However, the inventors have also found that, in some cases, a central strip can have a lower brightness, as illustrated in FIG. 3. FIG. 3 illustrates a distribution of brightness of light refracted out of a waveguide by an output element of a planar waveguide in different angular directions. The example distribution of FIG. 3 is produced when light is introduced to the output element from the right. The horizonal axis indicates a horizontal gaze direction Θ_{X} in degrees and the vertical axis indicates a vertical gaze direction Θ_{Y} in degrees. The greyscale colouring illustrates brightness from a maximum brightness (100, white) to a minimum brightness (0, black)—the range of brightness is not specifically constrained for illustrating the central strip. The central strip of lower brightness may occur because light is unlikely to couple out of the waveguide before interacting with both of the overlaid diffractive optical elements which make up the output element, and so only a small proportion of light is coupled out the waveguide close to the path along which light enters the output element.

The above-described higher-brightness strip and lower-brightness strip may each be visible to a user when viewing light output from the waveguide, and may affect the uniformity of the image displayed using the waveguide, degrading the wearer experience.

Accordingly, as an addition or alternative to the solutions provided in WO 2018/178626, it is desirable to provide a way of mitigating a lower-brightness strip in the light coupled out of the waveguide towards the viewer.

This specification corresponds to European application EP 22195747.5. A search report for that European patent application identified US 2018/0052276 A1 as an earlier disclosure. US 2018/0052276 A1 has a common priority claim with granted European patent EP 3571535 B1.

### SUMMARY

According to a first aspect, the present invention provides an optical device for use in an augmented reality or virtual reality display, comprising: a waveguide; an input diffractive optical element, DOE, configured to receive light from a projector and to couple the received light into the waveguide along a plurality of optical paths; an output DOE offset from the input DOE along a first direction and configured to couple the received light out of the waveguide and towards a viewer; a first turning DOE offset from the input DOE along a second direction different from the first direction; wherein the input DOE is configured to couple a first portion of the received light in the first direction towards the output DOE, and the input DOE is configured to couple a second portion of the received light in the second direction towards the first turning DOE and the first turning DOE is configured to diffract the second portion of the received light towards the output DOE.

The first portion and second portion of the received light follow different optical paths to reach the output DOE and produce overlapping patterns of light coupled out of the waveguide towards a user's eye. These overlapping patterns can help to smooth out any higher-brightness or lower-brightness central strips associated with individual optical paths.

Preferably, the output DOE is wider than the input DOE in the second direction, and the first turning DOE is configured to diffract the second portion of the received light in the first direction towards the output DOE.

Preferably, the input DOE comprises a first grating configured to diffract the first portion of the received light in the first direction and a second grating configured to diffract the second portion of the received light in the second direction.

Preferably, the first grating or the second grating comprises a blazed grating. For example, the first grating may have a blazed grating configured to efficiently couple light towards the output DOE.

Preferably, a repeating unit of the input DOE comprises a grid of rectangular elements each having a respective height perpendicular to a plane of the waveguide, wherein at least three of the rectangular elements have different heights. This provides a simple and easily-reconfigurable technique for constructing the input DOE.

More preferably, the grid of rectangular elements comprises a first region having a stepped series of rectangular elements, wherein the heights of the stepped series of rectangular elements change incrementally (i.e. increase or decrease) in one of the first direction and the second direction. In a preferred embodiment, the first region extends across the length of the repeating unit in the one direction and the heights of the stepped series of rectangular elements change in the one direction at regular intervals, such that the input DOE approximates a blazed grating for coupling light in the first direction.

As an additional preferred option, the grid of rectangular elements comprises a second region, offset from the first region in the other of the first and second directions, wherein an average height of rectangular elements in the second region is different from an average height of rectangular elements in the first region. This provides a simple technique for manufacturing a crossed grating with two grating vectors.

Preferably, the input DOE is further configured to couple a third portion of the received light in a third direction different from the first and second directions, the optical device comprises a second turning DOE offset from the input DOE along the third direction, and the second turning DOE is configured to diffract the third portion of the received light towards the output DOE. As a preferred option, the third direction is opposite to the second direction. This enables a symmetric construction where the input DOE and output DOE share a common central axis.

The first and second gratings may be arranged on a same surface of the waveguide or on opposing surfaces of the waveguide.

### BRIEF DESCRIPTION OF THE DRAWINGS

Embodiments of the invention are now described, by way of example, with reference to the drawings, in which:

FIG. 1 is a top view of a known waveguide;

FIG. 2 is another top view of a known waveguide;

FIG. 3 is a brightness map of light coupled out of a known waveguide;

FIG. 4 is a top view of a waveguide according to an embodiment;

FIG. 5 is a top view of another waveguide according to an embodiment;

FIG. 6 is a perspective view of two surfaces of a waveguide according to an embodiment;

FIGS. 7A and 7B are illustrations of an input diffraction grating for a waveguide according to an embodiment;

FIG. 7C is an illustration of an input diffraction grating for a waveguide according to an embodiment;

FIGS. 8A to 8D are illustrations of an input diffraction grating for a waveguide according to an embodiment;

FIG. 8E is an illustration of an input diffraction grating for a waveguide according to an embodiment.

### DETAILED DESCRIPTION

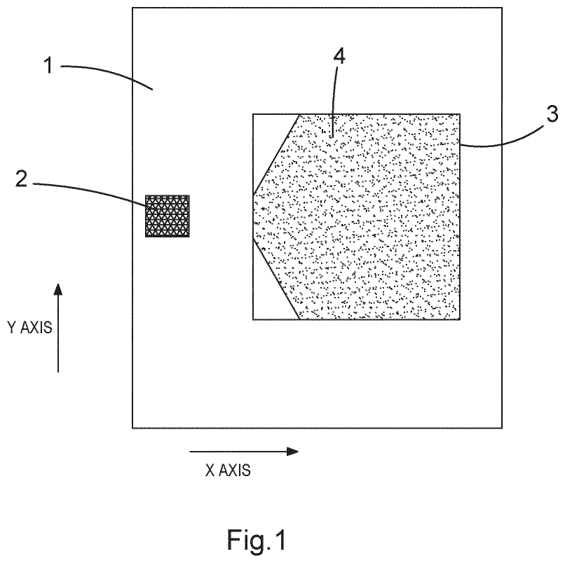

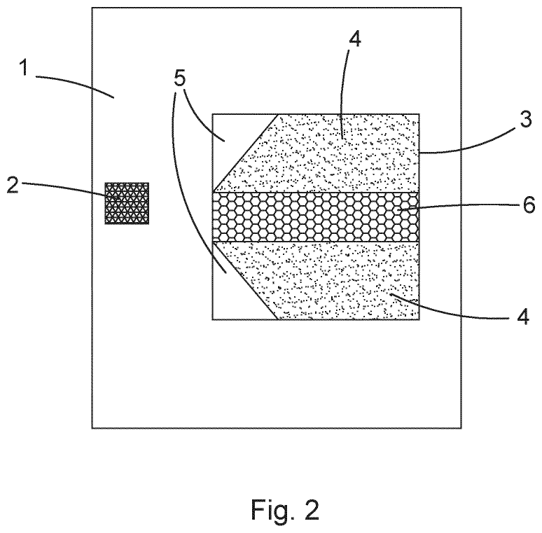

FIGS. 1 and 2 are top views of a known waveguide 1, as an example of a waveguide to which the claimed invention may be applied as a modification. In the known waveguide, an input diffractive optical element, DOE 2 (such as a diffraction grating) is provided in or on a surface of the waveguide 1 for coupling light from a projector (not shown) into the waveguide 1. The waveguide 1 is formed of a defined refractive index material such as glass or plastic. Light that is coupled into the waveguide travels by total internal reflection towards an output DOE 3, which may for example include a photonic crystal 4.

In a typical application, a projector introduces at least one beam of image light to the input diffraction grating 2, where the image light defines an image pupil, which represents a full image (i.e. contains all the angular information that defines an image) that an individual could perceive if their eye was correctly aligned with the image pupil. The photonic crystal 4 expands input light in two dimensions within the waveguide and couples light out of the waveguide, for example as previously described in WO 2016/020643 or WO 2018/178626.

The invention can also be applied to other waveguides comprising a diffractive optical element for coupling light out of the waveguide. For example, the invention may be applied to diffractive optical elements comprising a plurality of parallel grating lines, each grating line having a cross-section in a plane perpendicular to the lines.

Referring to FIG. 2, the output DOE 3 turns at least a part of the light coupled within the waveguide from the input DOE 2, such that light spreads over a two-dimensional area corresponding to the photonic crystal 4. Reference 5 in FIG. 2 indicates areas which the light coupled within the waveguide does not reach, because the light is not turned so far by the photonic crystal 4 and there is only one path for light from the input DOE 1 to the output DOE 2.

At the same time, it has been found that the image diffracted from output DOE 3 may in some cases have a central strip 6 which has a lower relative brightness than other parts. This effect is created due to the diffraction efficiencies of the diffractive optical structures formed by the array in the photonic crystal 4. In particular, only a relatively small proportion of light received from the input DOE 2 is diffracted directly out to the eye when it encounters the photonic crystal 4, without first being diffracted and turned through ±60° in the plane of the waveguide 1. (±60° is just an example configuration, and the light may be diffracted and turned through other angles by other photonic crystals.)

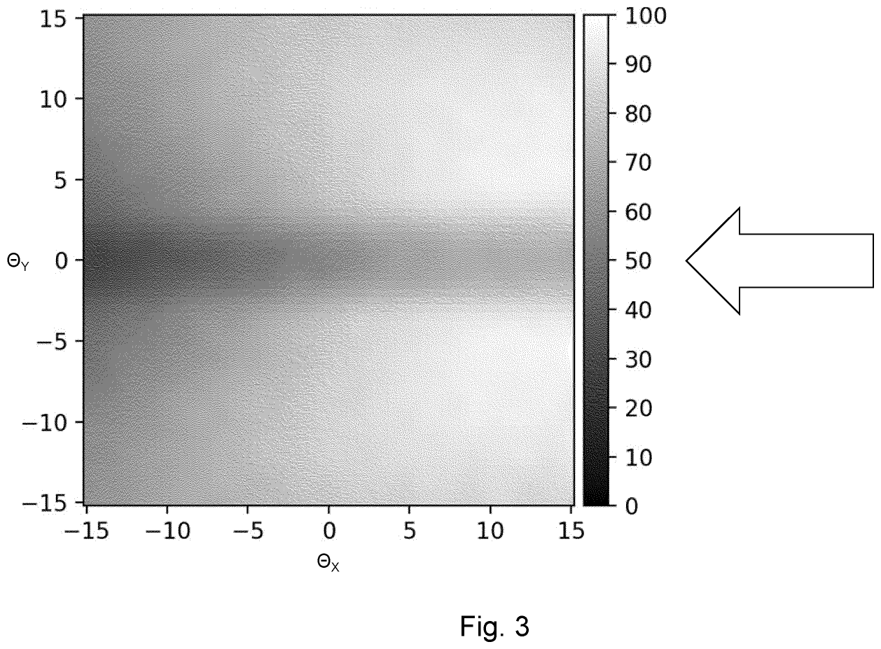

FIG. 3 illustrates an example of such a central strip with lower brightness. More specifically, FIG. 3 is a graph of brightness variations of light output in different angular directions (Ox along the horizontal axis and OY along the vertical axis) from the output DOE 3. This corresponds to different positions within an “eyebox” of an image visible to a user of the waveguide. Light coupled within the waveguide enters the output DOE 3 at a single entry point on one side, from the entry direction indicated by an arrow. As shown in FIG. 3, the dim central strip 6 extends in a direction parallel and away from the point of entry to DOE 3.

In order to mitigate the effects of such a dim central strip, waveguides are proposed in which light enters the output DOE via multiple entry points but from the same direction. This is achieved by guiding light within the waveguide along multiple paths from the input DOE to the output DOE.

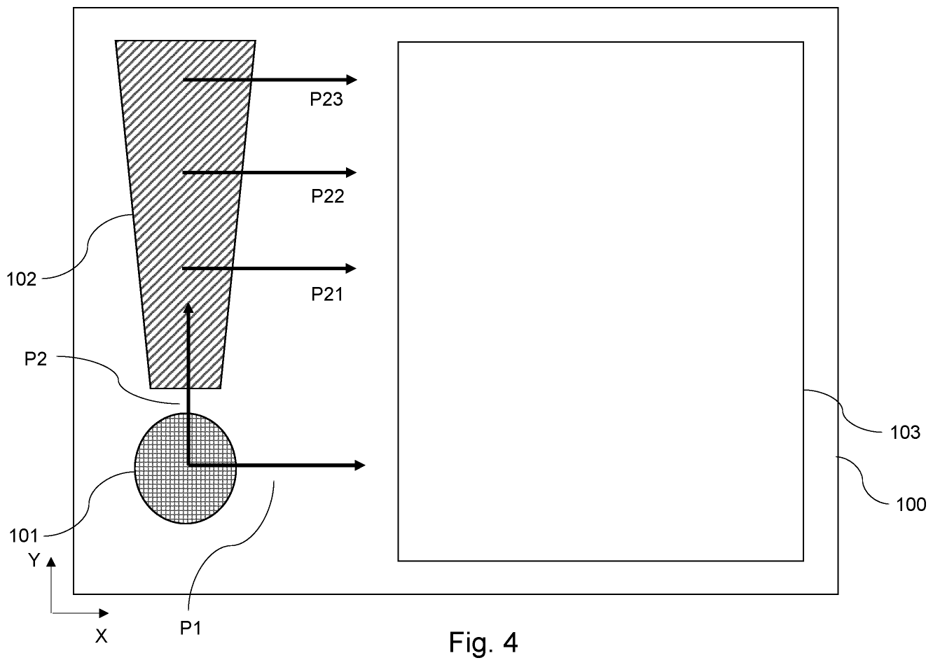

FIG. 4 is a top view of a planar waveguide 100 according to an embodiment.

As shown in FIG. 4, the waveguide 100 comprises a first DOE 101, a second DOE 102 and a third DOE 103.

Each of the first, second and third DOEs 101, 102, 103 may, for example, comprise a diffraction grating and/or a photonic crystal. The first, second and third DOEs 101, 102 and 103 may be arranged as surface elements on the waveguide or structures embedded in the waveguide, or a combination of both.

The first DOE 101 is configured as an input DOE, structured and arranged to receive light (from a projector not shown in FIG. 4) incident on the waveguide and to couple the received light into the waveguide along at least two directions towards second DOE 102 and third DOE 103 respectively.

The second DOE 102 is configured as a first turning and expansion DOE, structured and arranged to receive light travelling within the waveguide from the input DOE 101 and to diffract the received light within the waveguide towards the output DOE 103.

The third DOE 103 is configured as an output DOE, structured and arranged to couple light out of the waveguide. For example, the third DOE 103 may be similar to the output DOE 3 of FIGS. 1 and 2.

The waveguide 100 also comprises a bulk substrate suitable for guiding light using total internal reflection between the first, second and third DOEs. The bulk substrate may be a planar waveguide having a first surface and a second surface. The bulk substrate may be substantially flat. In some embodiments, the bulk substrate may comprise a curved section between the DOEs. For example, the bulk substrate may be configured to conform to the shape of an eyeglass surface. The bulk substrate may also have a substantially uniform thickness. More generally, the shape of the bulk substrate may be reconfigured so long as the bulk substrate guides light as described between the DOEs.

More specifically, the output DOE 103 is offset from the input DOE 101 along a first direction. The input DOE 101 is configured to couple a first portion P1 of received light in the first direction towards the output DOE 103.

Additionally, the first turning DOE 102 is offset from the input DOE 101 along a second direction. The second direction is different from the first direction and may, for example, be perpendicular to the first direction within the plane of the waveguide 100. The input DOE 101 is configured to couple a second portion P2 of received light in the second direction towards the first turning DOE 102. The first turning DOE 102 is configured to diffract the second portion P2 of the received light towards the output DOE 3. At the same time, the first turning DOE 102 diffractively expands the second portion P2 of the received light along the second direction. In other words, each time the second portion P2 of the received light interacts with the first turning DOE 102, a portion of the light is diffracted towards the output DOE 103 and the remainder of the light continues in the second direction by total internal reflection until the light interacts with the first turning DOE 102 again. These multiple interactions with the first turning DOE 102 produce multiple portions of the light travelling along parallel paths P21, P22, P23 etc. towards the output DOE 103, these paths being spread out along the second direction.

The output DOE 103 receives the first portion P1 of the received light at one entry point, and receives the multiple portions diffracted by the first turning DOE 102 at multiple other entry points along a common edge of DOE 103. Each entry point results in the production of a brightness pattern similar to FIG. 3, as such each brightness pattern will overlap across the “eyebox” region of DOE 103 contributing to the image seen by the user. The effect of the overlapping patterns is to reduce or eliminate the visible appearance of the dim central strip that exists for each input point as described above for each individual brightness pattern, which thus acts to reduce or mitigate the dim strip artefact that might otherwise be perceived when light output from the waveguide is viewed by a user.

FIG. 5 is a top view of a planar waveguide according to another embodiment. This embodiment differs from FIG. 4 in that the waveguide 100 additionally comprises a further second DOE 104 which is configured as a second turning DOE 102.

The second turning DOE 104 is offset from the input DOE 101 in a third direction which is different from the first and second directions. The second turning DOE 104 functions similarly to the first turning DOE 102 in that it is configured to receive a third portion P3 of light from the input DOE 101 and diffract the received light towards the output DOE 103. This can increase the number of entry points for light guided to the output DOE 103, and thereby further reduce or eliminate the dim central strip effect of the combined light output from the waveguide.

Preferably the third direction is opposite to the second direction. This configuration has the advantage that the input DOE 101 can couple light into the waveguide in both of the second and third directions, towards the first and second turning DOEs, using a single linear grating structure or one-dimensional photonic crystal structure. However, in other examples, the input DOE may couple light in a third direction that is unrelated to the first or second direction, and may even couple light in more than three directions within the waveguide.

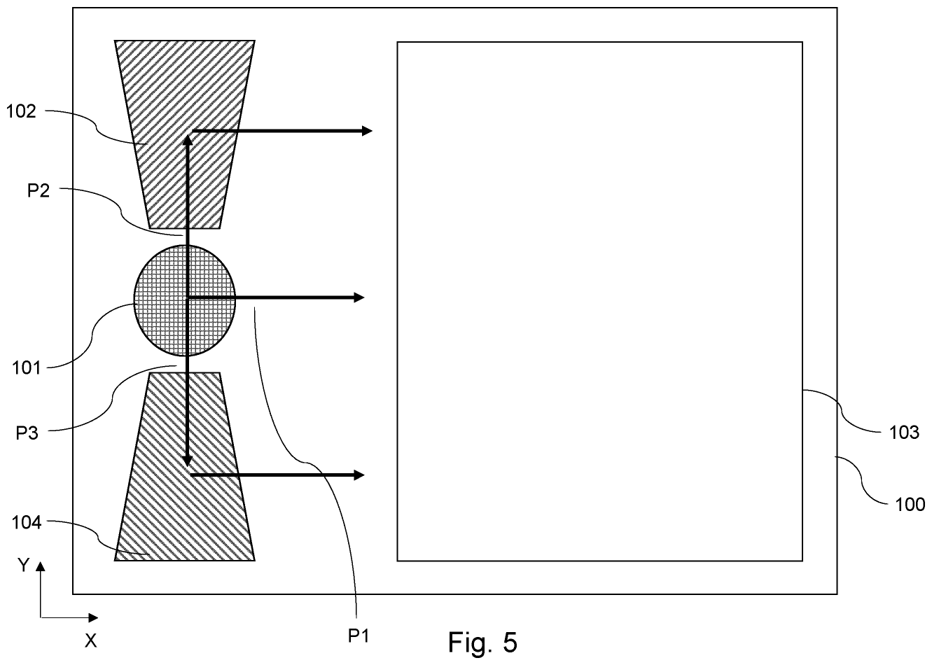

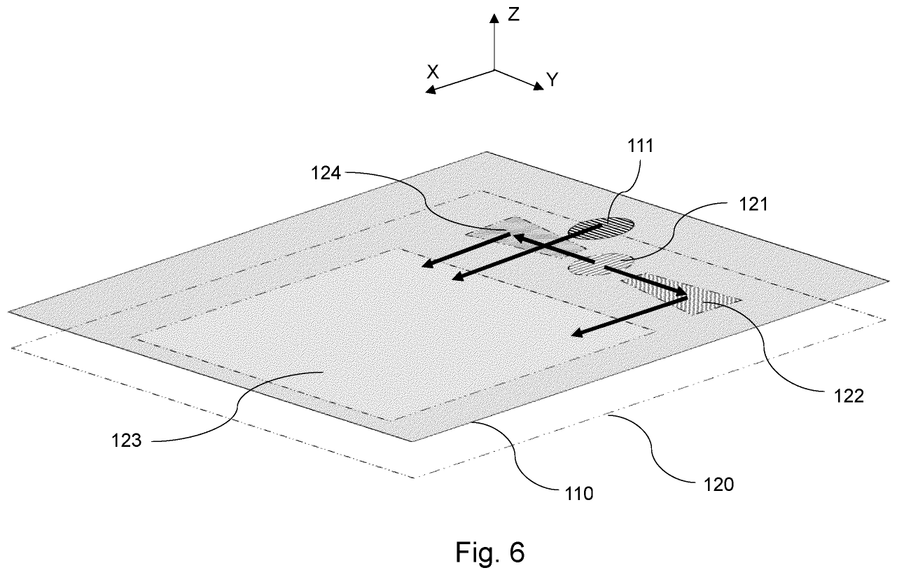

FIG. 6 is a perspective view of two surfaces of a waveguide according to an embodiment.

More specifically, in the embodiment of FIG. 6, the waveguide comprises a first grating 111 arranged on the first surface 110 and a second grating 121 arranged on the second surface 120. Together, the first grating 111 and the second grating 121 provide the function of the input DOE 101 described for FIG. 4 or FIG. 5. Preferably, the first grating 111 is a transmission grating configured to diffract light as it is received into the waveguide (for example received from a projector) and the second grating 121 is a reflective grating configured to reflect light within the waveguide and couple the light into the waveguide.

In one case, the first grating 111 is configured to couple the first portion P1 of the received light in the first direction towards the output DOE 123, and the second grating 121 is configured to couple the second portion P2 of the received light in the second direction towards the first turning DOE 122 (and optionally to couple the third portion P3 in the third direction towards a second turning DOE 124).

Alternatively, the roles of the first and second gratings may be reversed, such that the first grating 111 is configured to couple the second portion P2 of the received light in the second direction towards the first turning DOE 122, and the second grating 121 is configured to couple the first portion P1 of the received light in the first direction towards the output DOE 123.

In the example of FIG. 6, the first grating 111 is configured to selectively direct input light in the direction of output DOE 123, and avoid turning light in a direction equal and opposite output DOE 123. For example, the first grating 111 may be a blazed grating. On the other hand, the second grating 121 is configured to direct input light equally in the direction of first turning DOE 122 and in the direction of second turning DOE 124.

As an alternative, each of the first grating 111 and the second grating 121 may be configured to direct input light in any proportional combination of the direction of output DOE 123, the direction of the first turning DOE 122 and the direction of the second turning DOE 124. For example, each of the first grating 111 and second grating 121 may be individually similar to the input DOE 101 of FIG. 4 or FIG. 5.

In the embodiment of FIG. 6, the turning DOE(s) 122, 124 and the output DOE 123 may each be arranged on the first surface 110 or the second surface 120, or embedded in the waveguide between the surfaces 110, 120. Furthermore, each of the turning DOE(s) 122, 124 and the output DOE 123 may independently be duplicated on the first surface 110 and the second surface 120.

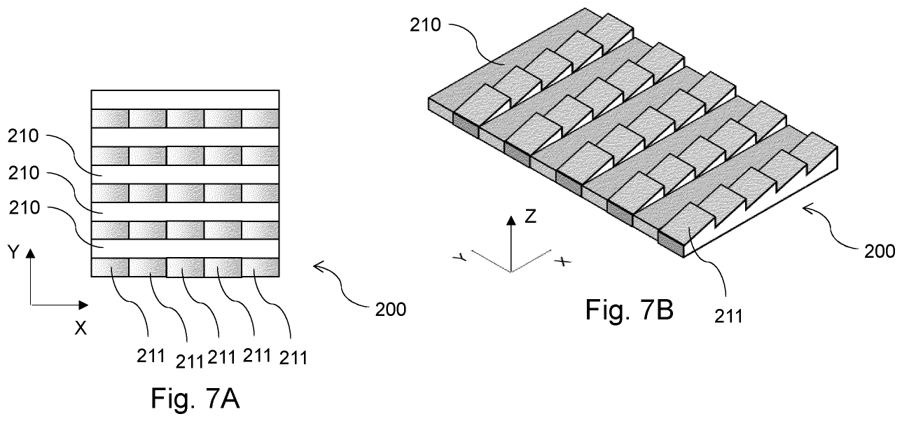

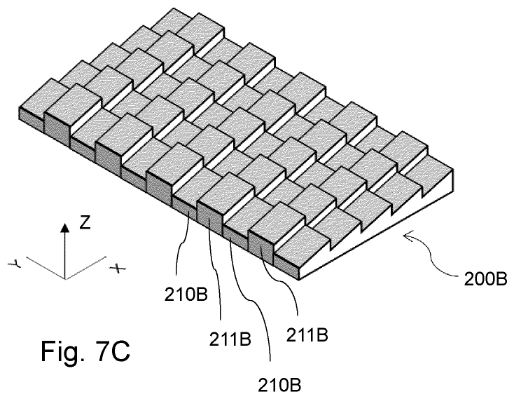

FIGS. 7A and 7B are illustrations of input DOE for a waveguide. For example, the input DOE of FIGS. 7A and 7B is suitable for the embodiment of FIG. 4 or FIG. 5.

In the embodiment of FIGS. 7A to 7B, the input DOE 200 comprises a blazed grating configured to direct input light in a first direction (the labelled X direction). The blazed grating comprises repeating rows 211 which extend perpendicular to the first direction (i.e. in the Y direction).

However, each row 211 also comprises regular notches 210 which extend in perpendicular to a second direction (the labelled Y direction). The regular notches 210 are configured to direct input light in the second direction (and optionally also in a third direction opposite to the second direction).

In this example, the regular notches 210 are flat portions in which the surface of the bulk waveguide is unmodified. However, the regular notches 210 may instead be raised above or embedded into the bulk waveguide. Additionally, the regular notches 210 may themselves comprise blazed sections configured to direct input light in the first direction, similarly to the rows 211 (for example as shown in the alternative input DOE 200B of FIG. 7C). However, an average height of the regular notches 210 is higher or lower than the average height of the rows 211.

FIG. 7A is a top view of the input DOE 200, in which the varying height of the blazed grating rows 211 is indicated using greyscale. FIG. 7B is a perspective view of the input DOE 200.

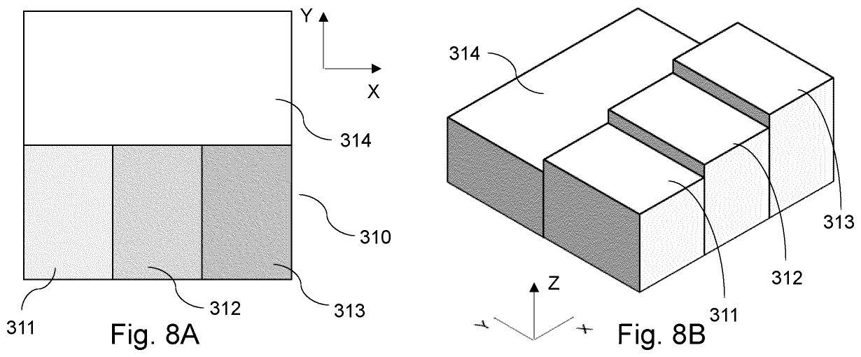

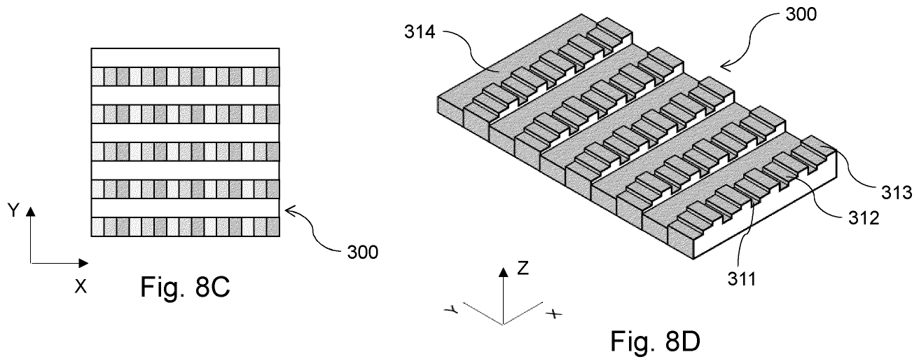

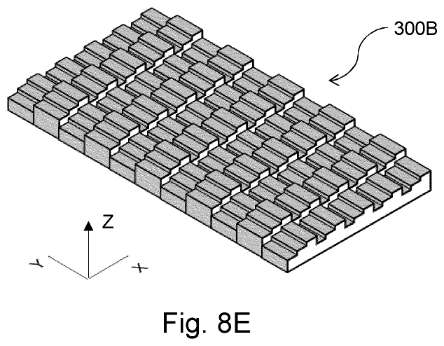

FIGS. 8A to 8D are illustrations of another input DOE for a waveguide. For example, the input DOE of FIGS. 8A to 8D is suitable for the embodiment of FIG. 4 or FIG. 5.

In the embodiment of FIGS. 8A to 8D, the input DOE 300 (FIGS. 8C and 8D) is a repeating structure comprising repeating units 310 (FIG. 8A). Each repeating unit 310 is made up of a grid of rectangular elements each having a respective height perpendicular to the plane of the waveguide (the plane being defined by the illustrated X and Y directions). FIGS. 8A and 8C are top views of the input DOE 300, in which the respective heights are indicated using greyscale. FIGS. 8B and 8D are perspective views showing the height dimensions in a repeating unit 310 and in the overall input DOE 300 respectively.

Referring to FIGS. 8A and 8B, in this example, the grid of rectangular elements comprises a first region 311, 312, 313 having a stepped series of rectangular elements, wherein the heights of the stepped series of rectangular elements decrease from the element 313 at one end to the element 311 at the other end. This stepped series approximates a smooth slope. When such a pseudo-slope is repeated across multiple repeating units 310 in the positive X direction (as shown in FIG. 8C), the overall effect is a repeating slope approximating a blaze grating configured to couple light in the positive X direction. This may also be referred to as a pseudo-blazed grating.

Additionally, in the repeating unit 310, the grid of rectangular elements comprises a second region 314 offset from the first region 311, 312, 313 in the Y direction, which is a direction perpendicular to the stepping of the rectangular elements of the first region. The second region 314 has an average height which is different from the average height of the first region 311, 312, 313. When the unit 310 is repeated in the Y direction to produce the input DOE 300 (FIGS. 8C and 8D), the alternating average height between the first region and the second region provides a linear grating configured to couple light equally in both the positive and negative Y directions.

In this example, the second regions 314 are flat portions in which the surface of the bulk waveguide is unmodified. However, the second regions 314 may instead be raised above or embedded into the bulk waveguide. Additionally, the second regions 314 may themselves comprise blazed or pseudo-blazed sections configured to direct input light in the first direction, similarly to the first regions 311, 312, 313 (for example as illustrated in the alternative input DOE 300B of FIG. 8E). However, an average height of the second regions 314 is higher or lower than the average height of the first regions 311, 312, 313.

Referring to the examples of FIGS. 8A to 8D, the combination of the blaze grating or pseudo-blaze grating having a grating vector parallel to the X direction and the linear grating having a grating vector parallel to the Y direction provides an input DOE which can couple a first portion of received light in the positive X direction, a second portion of light in the positive Y direction and a third portion of received light in the negative Y direction. This structure is therefore an example of a single grating structure which can fulfil the functions of input DOE 101 of FIG. 4 or FIG. 5.

Furthermore, because the grating having a grating vector parallel to the X direction is blazed or pseudo-blazed, a portion of light diffracted in the negative X direction is reduced, and therefore the input DOE can more efficiently couple light in the three directions of FIG. 5.

Pseudo-blazing can be extended to both of the X and Y directions by providing additional steps of the repeating unit in the Y direction. With this configuration, a portion of light diffracted in the negative Y direction can also be reduced, and the input DOE can more efficiently couple light in the two directions of FIG. 4. Similarly, blazing can be applied in two directions as a linear combination of one-dimensional blazing in each of the directions. Furthermore, blazing and pseudo-blazing can be combined in two directions using a linear combination.

1. An optical device for use in an augmented reality or virtual reality display, comprising:
a waveguide;
an input diffractive optical element (DOE) configured to receive light from a projector and to couple the received light into the waveguide along a plurality of optical paths;
an output DOE offset from the input DOE along a first direction and configured to couple the received light out of the waveguide and towards a viewer;
a first turning DOE offset from the input DOE along a second direction different from the first direction;
wherein the input DOE is configured to couple a first portion of the received light in the first direction towards the output DOE, and
the input DOE is configured to couple a second portion of the received light in the second direction towards the first turning DOE and the first turning DOE is configured to diffract the second portion of the received light towards the output DOE.

2. An optical device according to claim 1, wherein the output DOE is wider than the input DOE in the second direction, and the first turning DOE is configured to diffract the second portion of the received light in the first direction towards the output DOE.

3. An optical device according to claim 1, wherein the input DOE comprises a first grating configured to diffract the first portion of the received light in the first direction and a second grating configured to diffract the second portion of the received light in the second direction.

4. An optical device according to claim 3, wherein first grating or the second grating comprises a blazed grating.

5. An optical device according to claim 3, wherein a repeating unit of the input DOE comprises a grid of rectangular elements each having a respective height perpendicular to a plane of the waveguide, wherein at least three of the rectangular elements have different heights.

6. An optical device according to claim 5, wherein the grid of rectangular elements comprises a first region having a stepped series of rectangular elements, wherein the heights of the stepped series of rectangular elements change incrementally in one direction of the first direction and the second direction.

7. An optical device according to claim 6, wherein the first region extends across a length of the repeating unit in the one direction and the heights of the stepped series of rectangular elements change in the one direction at regular intervals, such that the input DOE approximates a blazed grating for coupling light in the one direction.

8. An optical device according to claim 6, wherein the grid of rectangular elements comprises a second region, offset from the first region in another direction of the first direction and second directions, wherein an average height of rectangular elements in the second region is different from an average height of rectangular elements in the first region.

9. An optical device according to claim 1, wherein the input DOE is further configured to couple a third portion of the received light in a third direction different from the first and second directions, the optical device comprises a second turning DOE offset from the input DOE along the third direction, and the second turning DOE is configured to diffract the third portion of the received light towards the output DOE.

10. An optical device according to claim 9, wherein the third direction is opposite to the second direction.

11. An optical device according to claim 3, wherein the first and second gratings are arranged on a same surface of the waveguide.

12. An optical device according to claim 3, wherein the first and second gratings are arranged on opposing surfaces of the waveguide.

13. A method for steering light in an augmented reality or virtual reality display, comprising:
receiving light from a projector at an input diffractive optical element (DOE) of a waveguide;
coupling the received light into the waveguide along a plurality of optical paths, comprising:
coupling a first portion of the received light in a first direction towards an output DOE; and
coupling a second portion of the received light in a second direction different from the first direction towards a first turning DOE;
diffracting the second portion of the received light towards the output DOE via the first turning DOE; and
coupling the received light out of the waveguide and towards a viewer via the output DOE.

14. The method of claim 13, wherein the output DOE is wider than the input DOE in the second direction, and the first turning DOE is configured to diffract the second portion of the received light in the first direction toward the output DOE.

15. The method of claim 13, wherein the input DOE comprises a first grating configured to diffract the first portion of the received light in the first direction and a second grating configured to diffract the second portion of the received light in the second direction.

16. The method of claim 15, wherein first grating or the second grating comprises a blazed grating.

17. The method of claim 15, wherein a repeating unit of the input DOE comprises a grid of rectangular elements each having a respective height perpendicular to a plane of the waveguide, wherein at least three of the rectangular elements have different heights.

18. The method of claim 17, wherein the grid of rectangular elements comprises a first region having a stepped series of rectangular elements, wherein the heights of the stepped series of rectangular elements change incrementally in one direction of the first direction and the second direction.

19. The method of claim 18, wherein the first region extends across a length of the repeating unit in the one direction and the heights of the stepped series of rectangular elements change in the one direction at regular intervals, such that the input DOE approximates a blazed grating for coupling light in the one direction.

20. A light steering means for use in an augmented reality or virtual reality display, comprising:
light guiding means;
input means to receive light from a light projecting means and to couple the received light into the light guiding means along a plurality of optical paths;
output means offset from the input means along a first direction and configured to couple the received light out of the light guiding means and towards a viewer;
a first turning means offset from the input means along a second direction different from the first direction;
wherein the input means is configured to couple a first portion of the received light in the first direction towards the output means, and
the input means is configured to couple a second portion of the received light in the second direction towards the first turning means and the first turning means is configured to diffract the second portion of the received light towards the output means.
